(19) United States
(12) Patent Application Publication
(10) Pub. No.: US 2026/0211734 A1
(43) Pub. Date: Jul. 23, 2026

(54) APPARATUS FOR SHARING RESOURCE, METHOD OF SHARING RESOURCE, AND NON-TRANSITORY STORAGE MEDIUM FOR STORING A COMPUTATIONLLY-IMPLEMENTED PROGRAM FOR SHARING RESOURCE

(71) Applicant: Seunghu CHI, Seoul (KR)

(72) Inventor: Seunghu CHI, Seoul (KR)

(21) Appl. No.: 19/447,075

(22) Filed: Jan. 13, 2026

(30) Foreign Application Priority Data
Jan. 17, 2025 (KR) 10-2025-0007239

(51) Int. Cl. G06F 9/50

(52) U.S. Cl. CPC G06F 9/5027

(57) ABSTRACT

Disclosed herein are an apparatus for sharing resources, a method for sharing resources, and a non-transitory storage medium for storing a computationally implemented program for sharing resources. In one aspect of the disclosures, the method of sharing a resource receives or collects information on a resource requestor and verifies a request of the resource requestor based on the information. The method derives information from registration information of a resource provider based on an artificial intelligence model and matches the derived information with the information on the resource requestor to determine a resource to be shared based on the matched information. The method also requests a delivery system to deliver the determined resource to the resource requestor based on the derived information. The derived information includes contribution points according to a ratio of a value of a resource provided by the resource provider to a social value calculated from the determined shared resource.

### CROSS-REFERENCE TO RELATED APPLICATIONS

This application claims the benefit of Korean Patent Application No. 10-2025-0007239, filed on Jan. 17, 2025, which is hereby incorporated by reference in its entirety.

### BACKGROUND

### 1. Field

The disclosures herein relate to an apparatus for sharing resources, a method for sharing resources, and a non-transitory storage medium for storing a computationally implemented program for sharing resources.

### 2. Discussion of the Related Art

Due to wealth imbalance resulting from industrialization and rapid changes in the climate environment, the imbalance of resources is becoming more severe.

In certain countries and regions, such resources are being wasted, and such national, social, and natural environmental costs are very large. Due to such an imbalance of resources, resources are being wasted in some countries or regions, while a very destitute life continues in other countries or regions.

According to a 2024 Oxfam report, since 2020, the wealth of the top five richest people in the world has doubled, while approximately five billion people worldwide became poorer during the same period. This report predicts that, although numerous people are experiencing poverty and hunger due to the imbalance of resources, the world's first trillionaire will emerge within 10 years.

Global conglomerates and the phenomenon of control being monopolized by a small number of parties are worsening inequality across the overall economy. In seven of the world's top 10 companies, a billionaire is the chief executive officer or a controlling shareholder.

To end extreme inequality, there is a need for the government to fundamentally redistribute the resources held by billionaires and large corporations to citizens in need in a voluntary manner.

For example, if the government implements and reorganizes democratic and effective regulation for the private sector, it may help realize a more universal world. Various legal measures have been proposed as ways to address this, for example, an ESG disclosure obligation (Environmental, Social, Governance disclosure obligation) for companies. According to the ESG disclosure obligation, a company must disclose environmental obligations regarding environmental protection, carbon emissions, energy use, and resource management.

However, with respect to the issue of protecting nature and resolving the imbalance of resources, there is a problem in that the sharing of resources is limited to a specific region or a specific society, or that it is difficult to solve this only through the efforts of some companies.

In addition, such ESG obligations have a problem in that there are ambiguous parts in measurable standards, making it difficult to measure such aspects, and there is also a problem in that countermeasures against climate change cannot be limited to the contribution of a specific country or region.

Meanwhile, even though such social obligations exist, there was a problem in that it was difficult to encourage people to fulfill these obligations, since there is no system by which they can be quantified.

### SUMMARY

An object of the disclosure below is to provide an apparatus for sharing resources, a method for sharing resources, and a non-transitory storage medium for storing a computer-executable program for sharing resources, which enable multiple countries, or societies or companies of those countries, to share resources without being limited to a region.

Another object of the disclosure below is to provide an apparatus for sharing resources, a method for sharing resources, and a non-transitory storage medium for storing a computer-executable program for sharing resources, which can help solve the problem of resource imbalance.

Another object of the disclosure below is to provide an apparatus for sharing resources, a method for sharing resources, and a non-transitory storage medium for storing a computer-executable program for sharing resources, which can share resources beyond such regional scopes or social categories, rather than resource sharing according to regional, social, or governmental efforts, and can help solve an imbalance problem.

Another object of the disclosure below is to provide an apparatus for sharing resources, a method for sharing resources, and a non-transitory storage medium for storing a computer-executable program for sharing resources, which can reduce waste of surplus resources and quantify the measurement of social contribution.

Disclosed herein is a method for sharing resources. In one aspect of the disclosures, the method receives or collects information on a resource requestor and verifies a request of the resource requestor based on the information. The method derives information from registration information of a resource provider based on an artificial intelligence model and matches the derived information with the information on the resource requestor to determine a resource to be shared based on the matched information. The method also requests a delivery system to deliver the determined resource to the resource requestor based on the derived information. The derived information includes contribution points according to a ratio of a value of a resource provided by the resource provider to a social value calculated from the determined shared resource.

The deriving information may further include an optimal support destination of the determined resource. The deriving information may further include an evaluation value of the determined resource.

The information on a resource requestor is crawled by an automated crawling operation through a public API (application programming interface). The delivery of the determined resource is delayed or fails, the matched information is retrieved, and an alternative provider or an alternative provision time window is generated from the artificial intelligence model.

In another aspect, an apparatus for sharing resources is disclosed. The apparatus includes a database storing data and a processor processing the data.

The processor is configured to receive or collect information on a resource requestor, verify a request of the resource requestor based on the information, and derive information from registration information of a resource provider based on an artificial intelligence model.

The processor is further configured to match the derived information with the information on the resource requestor to determine, based on the matched information, a resource to be shared, and request a delivery system to deliver the determined resource to the resource requestor based on the derived information. The derived information includes contribution points according to a ratio of a value of a resource provided by the resource provider to a social value calculated from the determined shared resource.

In another aspect, on-transitory storage medium for storing a computer-readable program for sharing a resource is disclosed. The program performs instructions comprising receiving or collecting information on a resource requestor, verifying a request of the resource requestor based on the information, and deriving information from registration information of a resource provider based on an artificial intelligence model. The program further performs instructions comprising matching the derived information with the information on the resource requestor to determine, based on the matched information, a resource to be shared, and requesting a delivery system to deliver the determined resource to the resource requestor based on the derived information.

According to the disclosure below, multiple countries, or societies or companies of those countries, can share resources without being limited to a region, and this can help solve the problem of resource imbalance.

According to the disclosure below, resources can be shared beyond such regional scopes or social categories, rather than resource sharing according to regional, social, or governmental efforts, and this can help solve an imbalance problem.

According to the disclosure below, waste of surplus resources can be reduced and the measurement of social contribution can be quantified, thereby helping induce a donation culture while improving resource efficiency and preserving the environment.

### BRIEF DESCRIPTION OF THE DRAWINGS

FIG. 1 discloses an embodiment of an apparatus for sharing resources disclosed below.

FIG. 2 illustrates information and metadata about a shared resource registered by an information registration module according to a disclosed embodiment.

FIG. 3 discloses an example of receiving information to find a demander or requestor who needs resources according to a disclosed embodiment.

FIG. 4 discloses an embodiment of providing a resource determined according to a disclosed embodiment.

FIG. 5 discloses an embodiment a method for obtaining output information for each shared resource according to a disclosed embodiment.

FIG. 6 shows an embodiment of a method for sharing resources according to a disclosed embodiment.

### DETAILED DESCRIPTION

Reference will now be made in detail to the preferred embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the present invention.

In the embodiments, an engine, various analysis tools, a module, and the like may be implemented as a physical device, a device combined with the physical device, or software.

When an embodiment is implemented as software, it may be stored on a computer-readable non-volatile storage medium, installed on a computer or the like, and executed by a processor.

Hereinafter, a resource mainly refers to goods needed by people, but is not limited thereto, and may include, depending on circumstances, information that can be shared, or economic or environmental benefits. For example, a resource may include a material resource, a human resource, a financial resource, information provided based on such resources, or a service, and the like.

Sharing of resources means sharing such resources or information, sharing economic benefits, or providing or receiving the same.

An example of an apparatus for sharing resources described below is mainly described as an example performed based on cloud computing systems, but may also be performed on on-premise computer systems.

Various steps processed by a processor disclosed below may also be implemented by a computer-executable program or software.

Recent advances in communication technology have enabled information worldwide to be exchanged quickly.

Short-range wireless communications such as Wi-Fi and Bluetooth and mobile communication technologies enable remote information sharing. And even in extreme environments such as the Ukraine-Russia war, communication technology using satellites has enabled the situations or information to be shared worldwide.

Meanwhile, cloud computing technology has expanded computing resources to rapidly process large volumes of information, and, in combination with state-of-the-art information processing technology such as artificial intelligence, has enabled more accurate processing of information.

Such technologies have developed unevenly depending on regions, so that, in general, people or regions that benefit from such technologies become wealthier over time, while people lacking material resources become poorer, thereby intensifying the imbalance. Such wealth imbalance has intensified polarization and has also intensified differences in the ability to respond to environments such as climate.

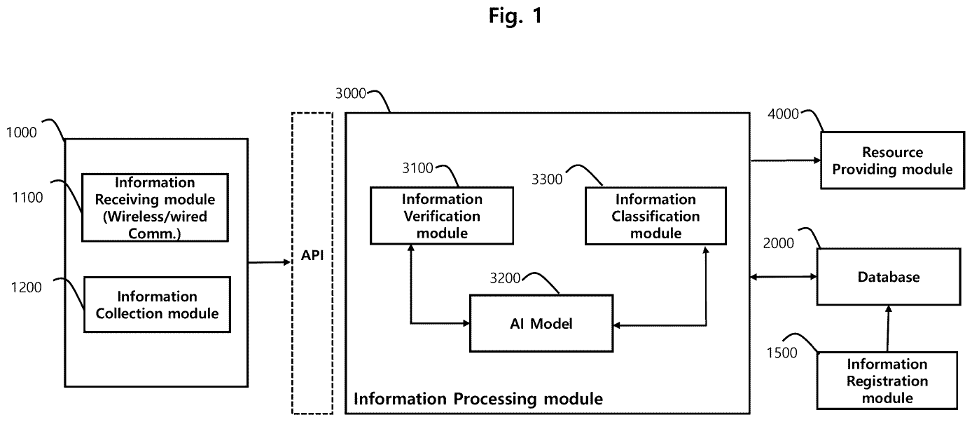

FIG. 1 discloses an example of an apparatus for sharing resources disclosed below. The example of this figure includes a receiving module 1000, an information registration module 1500, a database 2000, an information processing module 3000, and a resource providing module 4000.

First, the database 2000 receives and registers metadata, which is information about shared resources respectively provided from providers that are entities capable of providing surplus resources, donation resources, and service resources.

For example, each individual provider or a person in charge of a company may register and store surplus resources that are unused or can be donated.

For example, a hospital or a doctor may provide a treatment service that can be shared, rather than a surplus resource. In this manner, a service may be provided through one's activities. Here, for convenience, a service provided by a person is also referred to as a surplus resource or a resource.

The information registration module 1500 receives information about a service that may include information and economic benefits in material resources provided by such resource providers such as individuals or companies. The information registration module 1500 may store the received information and metadata about the information in the database 2000.

The database 2000 may register and store, as registration information, metadata including characteristics of each resource, a shareable period, a deadline for resource sharing, or a use period of a shared resource, with respect to resources provided by a provider and including material and economic benefits.

The registration information may include, for example, a provider identifier, a provider location, a resource type (such as goods, services, currency, points, etc.), a kind of resource, a quantity, a providable time, a desired region for provision, storage conditions of the resource, an expiration period, and a risk of damage, but is not limited thereto.

The receiving module 1000 may receive information that requires a shared resource. The receiving module 1000 may include an information receiving module 1100 and an information collection module 1200.

For example, the information receiving module 1100 of the receiving module 1000 may receive various types of information from a wired communication network or a wireless communication network. When a user who needs a specific resource or help delivers a request through a wireless communication network, the information receiving module 1100 may receive the request.

For example, when water and the like are insufficient due to a climate crisis in a certain region in Africa or a specific shared resource is insufficient, a person who needs the same or a person who helps the same may transmit a request for the corresponding shared resource to the receiving module 1000.

The information collection module 1200 of the receiving module 1000 may collect information from the Internet and the like to find a person who needs a shared resource or help. For example, the information collection module 1200 may collect information related to an urgent request for supplies or a request for a shared resource posted by an individual or a group on an SNS (Social Networking Service) and the like.

Information received or collected by the receiving module 1000 is transmitted to the information processing module 3000.

The information processing module 3000 may include an information verification module 3100, an AI model 3200, and an information classification module 3300.

The information processing module 3000 may have a platform for receiving and collecting information, and may include an API (Application Programming Interface) as an interface for receiving and collecting information.

The information processing module 3000 may match received information or collected information to a person in need who most needs resources.

For such a matching method, various classification algorithms of the AI Model may be used, and the matching method is not limited herein.

The information processing module 3000 may verify information received from the receiving module 1000, and, based on metadata including registration information, may classify, among information about shared resources stored in the database 2000, a shared resource that best matches a request received and verified by the receiving module 1000.

The information verification module 3100 may determine user authentication of a provider or authenticity of related information received or collected by the receiving module 1000.

The information verification module 3100 may determine whether request information corresponds to a situation where a shared resource is actually needed, by considering the authenticity of a request for a shared resource received by the receiving module 1000 in view of a region, a location, a situation, a requester, and surrounding circumstances related to the request information. That is, the information verification module 3100 may determine information on whether a situation requires a shared resource request by considering various circumstances.

For example, the information verification module 3100 may infer authenticity of a request or received information regarding a shared resource based on the AI model 3200, and may determine authenticity of the request or information based on evidence or grounds.

For example, the information verification module 3100 may verify, with respect to shared resource request information received by the receiving module 1000, whether the requester is a requester who actually needs a shared resource, whether the requester's situation needs a shared resource, or whether the requester is in a situation in which the requester should request a shared resource.

As another example, for information arbitrarily collected by the receiving module 1000 on the Internet, the information verification module 3100 may obtain information about a person, a group, a region, and the like that needs the corresponding shared resource from a received URL or content using the AI model 3200.

The information classification module 3300 may perform matching between information verified by the information verification module 3100 and data stored in the database 2000 based on the AI model 3200.

That is, when the information verification module 3100 determines that a request for a shared resource received or collected by the receiving module 1000 is true, the information classification module 3300 may execute the AI model 3200 based on metadata stored in the database 2000, classify an optimal shared resource stored in the database 2000 for the request received by the receiving module 1000, estimate an amount of the classified resource, and classify a storage location or a providing method of the optimal shared resource.

The information processing module 3000 transmits information regarding the identified optimal shared resource to the resource providing module 4000.

The resource providing module 4000 may deliver, to a person or a group that requested a shared resource, the shared resource registered in a database 2000.

The resource providing module 4000 may provide, to a requester or a group that requested a shared resource, the information verified by the information processing module 3000 and the classified shared resource.

In the case of a physical resource, the resource providing module 4000 may cause the resource to be delivered to the requester from a place where the resource is stored so that the resource can be delivered to the requester.

Since metadata stores, in the information classification module 3300, a location of a resource that can be provided and a providable method and the like, the resource providing module 4000 may provide the resource such that a requester who requested the resource can easily obtain the resource from a resource repository (not shown) in a region selected accordingly.

In the example of this figure, the receiving module 1000, the information processing module 3000, the information registration module 1500, the database 2000, and the resource providing module 4000 are shown as one drawing, but may be located in different regions or countries, respectively.

The information processing module 3000 may be a server or a cloud computing system including one or more processors, or an edge cloud computing system located in a certain region. The receiving module 1000, the information processing module 3000, the database 2000, and the information registration module 1500 may be displayed, in the form of a platform, to a provider that intends to share resources.

The resource providing module 4000, as a system at a resource providing site, may directly provide a resource to a requester by executing a providing method of a resource determined by the information processing module 3000 or registered in the database 2000.

Alternatively, the information processing module and the like may be a computer-executable program implemented as software in a computing system.

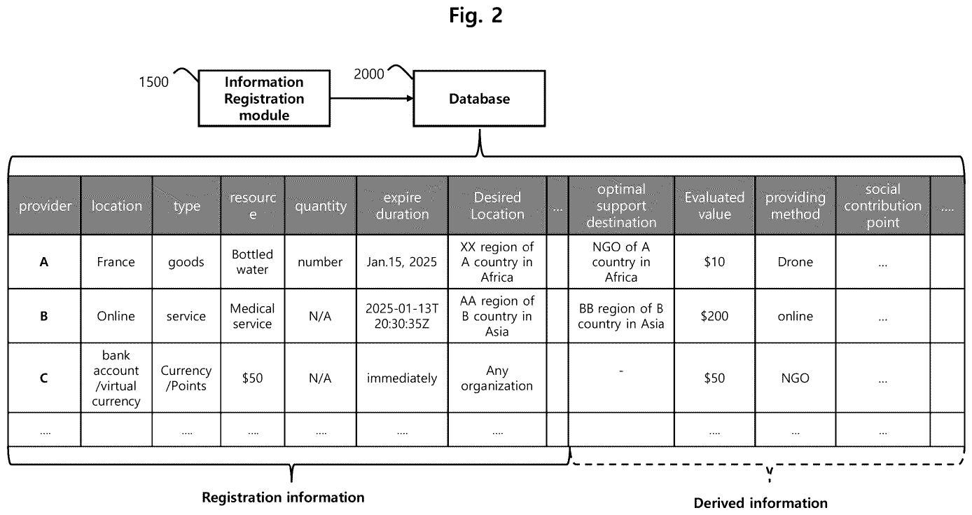

FIG. 2 illustrates information and metadata about a shared resource registered by the information registration module 1500 according to a disclosed example.

A provider of resources may register a shared resource or a surplus resource in the apparatus according to the disclosed embodiment. A resource provider may register, online, providable goods, a service, an amount of money, or virtual points and the like, in the database 2000 via the information registration module 1500.

The embodiment may assign an anonymous identifier and the like to a provider. Such an identifier may increase reliability of a provided resource through the provider. Here, for convenience, identifiers of providers are indicated as A, B, and C.

The disclosed example discloses an example in which provider A provides bottled water to people suffering difficulties such as water shortages in a specific country in Africa.

A provider may select and register the provider's location, a provided resource type, a kind of the resource, a quantity, and a region where the provider desires to provide help or share resources, and the like.

This figure discloses an example in which provider A provides X units of bottled water as shared goods from a specific region in France to an XX region of A country in Africa on Jan. 15, 2025.

And provider B may register a plan to provide, online, a medical service as a service from (a specific region) to an AA region of B country in Asia at 20:30 on Jan. 31, 2025.

As another example, provider C shows an example of donating by immediately providing, regardless of region, an amount on the order of 50 dollars in a bank account of a specific (CC) country, online points, virtual currency, and the like.

Although not shown in this embodiment, an identifier (ID) related to goods, a service, and currency, which are resources to be registered for registering resources, may be assigned.

This identifier may be automatically generated according to classification of goods, classification of a service, and classification of currency, and may have a serial number in the database. That is, to identify a resource, the resource may be identified by an identifier including letters and numbers, such as A101, B201, C103, . . . , and the like. In this manner, a provider may register, in the information registration module 1500, information such as the provider themself, a provider location, a resource type, a kind of the resource, a quantity, an expire duration for which the resource can be provided, or a location where the provider intends to provide the resource.

Meanwhile, when a resource provider registers a resource in the information registration module 1500, the information registration module 1500 may, through an AI model of an information processing module (not shown), classify or generate an optimal support destination where the provided shared goods can actually be supported, a value of a resource to be shared, and methods of providing the same to a person who actually needs resources.

That is, when Provider A donates bottled water to a donation site located in the provider's area and registers it, the AI model can, based on this information, determine the optimal support location closest to the intended donation site, calculate an evaluation value comparable to that of the provider's area, and derive the most suitable method for delivering the resource to the support location.

In this figure, the shared item provided by Provider A, namely a bottle of water, can be generated as an NGO organization in Country A in Africa, and the provision value (10 dollars) as well as the method by which the NGO can deliver it can be derived. Such derived information may be calculated by the AI model based on registration information registered by the provider in the database 2000.

In this example of the figure, among the organizations pre-registered in the database 2000, the NGO in Country A in Africa is derived as providing bottled water of the corresponding value to the XX region, with the providing or delivery method (e.g., drone) being determined. For example, the method of providing resources can be derived by using linear programming or mixed integer programming so as to optimize the delivery route or minimize the provision cost.

Also for provider B, based on the registration information entered by provider B, the AI model is configured to compute results including, an optimal support destination where the shared resource provided by provider B can be shared, an evaluated value, a providing method, and the like.

Although not shown herein, the derived information may be computed by the AI model to include factors such as a value of a resource provided by each provider, the frequency of provision, and the urgency of the items supplied and the like, and based on these factors, social contribution points may be calculated for each provider.

Such social contribution points may be represented, by means of various verification and authorized methods, as an indication of each provider's level of social contribution. Such a system may be configured to quantitatively evaluate a degree of social contribution for a provider and can additionally measures for enhancing social benefits for social contribution points.

As described above, both the registration information registered by a provider in the database 2000 and the derived information calculated using the AI model and the like based on the registration information may all become metadata about a shared resource.

That is, input data of the AI model becomes registration information registered by a provider, and output data may be derived information.

Accordingly, the database 2000 may include registration information that is a part registered by a provider and derived information obtained by the database 2000 or the AI model based on the registration information.

The derived information calculated by the AI model may be based on various pieces of information. For example, by matching providers' past behaviors or people having similar patterns, when a first provider provided similar goods, a service, or a donation in the past, the derived information may be obtained as a support destination similar to a previous one.

The derived information may be obtained by filtering information according to classification centered on such a provider's past providing history. Or, and, derived information may be obtained based on target content such as urgency of a resource provided according to attributes of provided goods, a service, or a donation, or based on a donation target object.

For example, an optimal support destination may be classified by applying a machine-learning classification model based on characteristic information of an input resource, such as a location, a type, and a quantity.

As another approach, a weight may be assigned to a provider's contribution history and urgency of a provided resource, and hybrid-type derived information may be obtained based thereon.

And, social contribution points may be proportional to evaluated values shared by each provider.

As a specific example, provider N registers providing information such as the provider's location information, a providing type, a specific resource name and quantity, and an available providing time.

Then, an AI model linked with the corresponding database can generate, based on the provided information, an optimal support destination, a resource value, a providing method, and the like.

The AI model may, on a distance basis or by receiving input to a demand prediction model, perform demand prediction on a distance basis or by time-series or regression analysis.

The AI model may evaluate a resource value at a price closest to a market price by including a regression model and the like, and such an evaluated resource value, as social contribution points that are a social value index, may provide, to the provider, a renormalized contribution value as points.

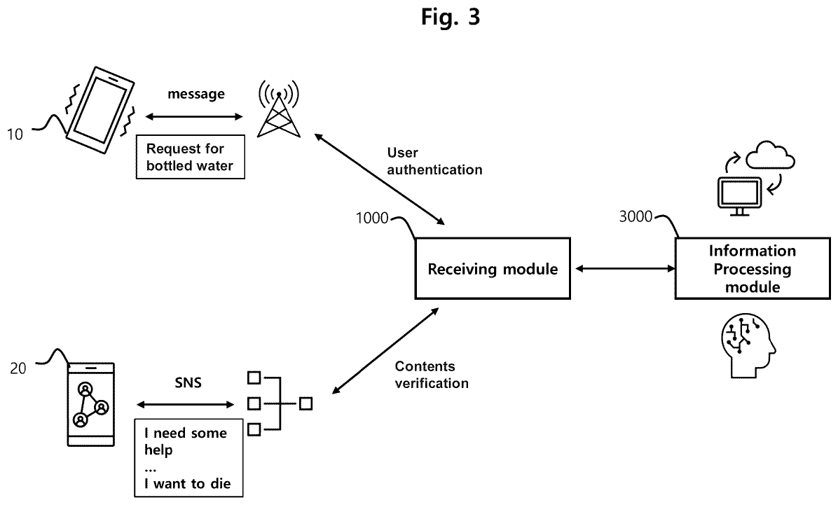

FIG. 3 discloses an example of receiving information to find a requestor or demander who needs resources according to the above disclosure.

In one embodiment, the receiving module 1000 may receive resource request information from a resource requestor or demander who needs resources or assistance, or from a support organization (e.g., NGO, public institution, local organization, etc.) supporting the request. The receiving module 1000 may include an information receiving module 1100 and an information collection module 1200, where the information receiving module 1100 may receive request information through a mobile communication network, a wired communication network, or a wireless communication network, and the information collection module 1200 may collect resource request-related information from the Internet, SNS platforms, or websites.

First, a demander who needs bottled water or daily necessities and the like, or a support group supporting the demander, may request, via a mobile communication network, necessary resources from the receiving module 1000 according to the embodiment by using a terminal 10 and the like.

In this example, a demander or a support organization may transmit request information for required resources to the information receiving module 1100 by using a terminal 10. For example, through a messaging function, an application, a web form, or an API call of the terminal 10, a resource request message such as “1,000 bottles of 500 mL bottled water are needed” or “medical service support required” may be transmitted. The information receiving module 1100 may receive the message and deliver it to the information processing module 3000.

In the example of this figure, necessary bottled water is requested using a message function of the terminal 10, and the receiving module 1000 receives the request and transmits the request to the information processing module 3000.

The Information verification module of the information processing module 3000 may be configured to request user authentication for the received message. The Information verification module may determine whether the request in the corresponding message is authentic based on user-based authentication information.

For example, when the user is authenticated, the request in the message may be determined to be authentic.

The Information verification module of the information processing module 3000 may, using the AI model, determine a situation of location information where the requester of the requested message is located or a transmission region, and may determine authenticity of the request through the message.

For example, the Information verification module may additionally determine, using the AI model, whether there is an earthquake, a disaster, or severe economic difficulty in the requester's region.

Accordingly, the Information verification module of the information processing module 3000 may determine a related region or a situation using authentication for the requester and the AI model, and may determine authenticity of the corresponding request information.

The information processing module 3000 may also predict “which supplies will be needed in which region” by using the AI model and may perform pre-matching. Such pre-prediction enables proactive response before an emergency situation occurs.

For example, when a disaster occurs, it is possible to predict, based on past disaster data, that demand for bottled water will surge in a specific region, and it is possible to connect an NGO in the corresponding region and a bottled-water donor in advance.

In this example, the information processing module 3000 may include an information verification module 3100 configured to perform user authentication or requester authentication for the received request message. For example, the information verification module 3100 may request user-based authentication information such as a user account of the terminal 10, phone number authentication, organization registration number authentication, electronic signature, or two-factor authentication, and may determine authenticity of the request message according to the authentication result. For example, when authentication succeeds, the request message may be determined to be highly likely true.

In addition, the information verification module 3100 may further determine authenticity of the request message by using the AI model 3200 in addition to authentication information. For example, the information verification module 3100 may infer whether the request corresponds to a situation in which resources are actually needed, by using location information of the requester, situational information of the transmission region, and public data related to disasters, climate, or economic crises. For example, the AI model 3200 may analyze whether an earthquake, flood, drought, epidemic, or severe economic crisis has occurred in the request region, and authenticity of the request may be determined based on the analysis result.

Accordingly, in one embodiment, the information verification module 3100 may determine authenticity of a request message and necessity of support by combining (i) an authentication result and (ii) a situational judgment result by the AI model (3200). For example, when authentication succeeds and the AI model (3200) calculates a high possibility of a surge in demand for bottled water in the corresponding region, the request message may be determined to be a request that actually requires support.

Meanwhile, the receiving module 1000 may not only receive information about requested resources but may also collect information that needs resources or help.

For example, user data may be collected from various Internet sites or SNS platforms through functions such as crawling. For example, messages may be crawled using a public API (application programming interface) of an SNS platform, or a website may be parsed using web scraping, or an automated crawling operation may be performed.

The example of this figure discloses an example of collecting, through crawling and the like, a case where a specific user appeals economic difficulty on an SNS. The receiving module 1000 may collect a message or related content from an SNS platform or a website and transmit the same to the information processing module 3000.

The information processing module 3000 may receive, from the receiving module 1000, contents posted in a mobile phone message, an SNS message, or content of a website and the like, and may verify authenticity of a message or content using the AI model with respect to received or collected information or a message.

For example, the Information verification module of the information processing module 3000 may determine, using the AI model, whether a situation involves ongoing economic difficulty according to an SNS message or content.

The AI model may classify authenticity of the corresponding request by considering context such as continuity of an SNS message or content. And the information processing module 3000 may, after verifying requested information or a collected message, classify an optimal provided resource, a providing location, and providing methods suitable for the information or the message.

In one embodiment, the receiving module 1000 may collect, in addition to directly received request information, information indicating that resources or assistance are needed from the Internet or SNS platforms. For example, the information collection module 1200 may perform crawling, web scraping, public API (application programming interface) calls, RSS collection, or automated parsing to collect posts, messages, or content related to a specific region or specific keywords (e.g., “water shortage,” “emergency support,” “relief supplies,” “medical service needed”).

For example, when a specific user uploads a post on an SNS platform appealing for economic hardship or a need for relief, the information collection module 1200 may collect the post and associated content (such as comments, descriptions of attached images, location tags, posting time, etc.) and deliver them to the information processing module (3000). In this case, the information collection module 1200 may generate and deliver collection metadata such as the URL of the collected target, the account of the poster, the posting time, the posting location, the original content, and extracted keywords.

In one embodiment, the information processing module (3000) may verify authenticity of SNS messages or web content received from the information collection module 1200 through the information verification module 3100. For example, the information verification module 3100 may analyze, by using the AI model (3200), continuity of content, context, past posting history, and whether similar requests are repeatedly made from multiple sources in the same region, and may determine whether the situation corresponds to “continuous economic hardship” or “a situation requiring urgent relief.” In addition, the information verification module 3100 may determine authenticity of the content by comprehensively considering reliability of the collected URL, credibility of the source, and cross-verification results for the same event.

In one embodiment, the information processing module 3000 may perform pre-prediction and pre-matching of “which resources may be needed in which regions” by using the AI model 3200, not only when received or collected information exists. For example, based on past disaster data, seasonality, climate variations, and changes in economic indicators, a possibility of a surge in demand for bottled water in a specific region may be predicted. The information processing module 3000 may, based on the predicted demand result, pre-connect a support organization (e.g., NGO) in the corresponding region with a bottled water donor, or may preferentially select, as candidates, shared resources registered in the database 2000 that can be provided to the corresponding region. Accordingly, proactive response may be possible before an emergency situation occurs.

In one embodiment, the information processing module 3000 may classify, with respect to request information or collected information determined to be true by the information verification module 3100, which resource type (e.g., goods/services/money) the information relates to and what level of urgency/demand it has. The information processing module 3000 may deliver verified request information (e.g., location, type/quantity of required resources, request time, urgency score, etc.) to the information classification module 3300, and the information classification module 3300 may be configured to match the verified request information with shared resource metadata stored in the database 2000 so as to classify the most suitable provided resource, provision location, and provision method for the request.

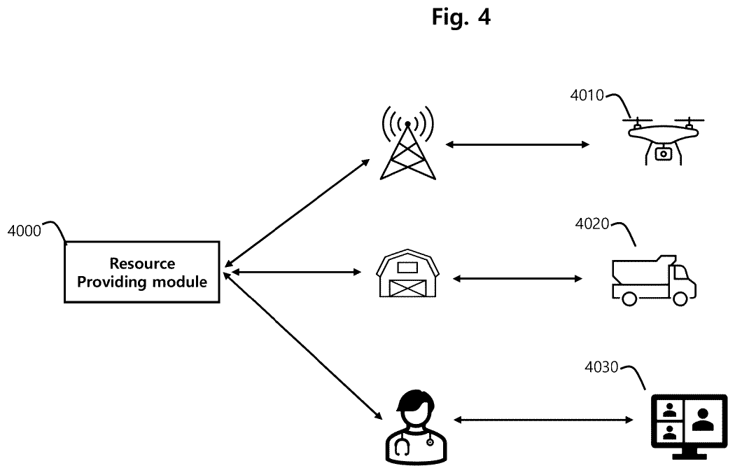

FIG. 4 discloses an example of providing a resource determined according to the above disclosure.

In this manner, when the information processing module determines, based on a received message or a collected message or content, provision of a registered resource to a person or a group in need of help, the resource providing module 4000 may, according to the determination of the information processing module, provide the registered resource to a person or a group that will provide the resource to the person.

In one embodiment, the information processing module 3000 may verify request information or messages/content received or collected from the receiving module 1000 through the information verification unit 3100, and may identify, by using the information classification unit 3300 and the AI model 3200, a shared resource most suitable for the request among shared resource metadata stored in the database 2000.

The information processing module 3000 may generate provision instruction information including a resource identifier of the identified shared resource, an optimal support destination, an evaluation value, a provision method (e.g., drone 4010, delivery truck 4020, online 4030), an expected provision time, and provision route information, and may deliver the provision instruction information to the resource providing module 4000.

In one embodiment, the information processing module 3000 may verify request information or messages/content received or collected from the receiving module 1000 through the information verification unit 3100, and may identify, by using the information classification unit 3300 and the AI model 3200, a shared resource most suitable for the request among shared resource metadata stored in the database 2000.

The information processing module 3000 may generate provision instruction information including a resource identifier of the identified shared resource, an optimal support destination, an evaluation value, a provision method (e.g., drone 4010, delivery truck 4020, online 4030), an expected provision time, and provision route information, and may deliver the provision instruction information to the resource providing module 4000.

In one embodiment, the resource providing module 4000 may provide a resource to a requester or a person/organization in need, based on provision instruction information received from the information processing module 3000 and derived information stored in the database 2000, namely provision method, provision location, provision means, provision schedule, and the like. The resource providing module 4000 may record provision status (e.g., preparation, release, transportation, delivery, completion) and provision results in the database 2000 during execution of provision, and after completion of provision, may re-deliver to the information processing module 3000 information required for calculating increments of social value and social contribution points based on the provision results.

The resource providing module 4000 may deliver a resource to a requester or a needed person/group according to a providing method classified by the AI model of the information processing module or registered as derived information in the database.

According to the above example, when provider A registers bottled water, which is goods, in the Database and decides to provide the bottled water to an XX region of A country in Africa, the goods may be delivered to a requester according to a providing method, which is derived information obtained from the AI model based on registration information registered by the provider.

The resource providing module 4000 may deliver goods to a requester by using a drone 4010 according to a providing method among derived information registered in the Database by the AI model.

The resource providing module 4000 may deliver goods to a requester by using a delivery truck 4020 from a place where donated goods of an optimal support destination are stored, according to a providing method among derived information registered in the Database by the AI model.

In one embodiment, assuming that Provider A registers 1,000 bottles of bottled water as a material resource and a resource identifier A101 is assigned, the information processing module 3000, as in the embodiment of FIG. 3, may verify authenticity of a received request message (e.g., “water shortage in XX region”) through the information verification module 3100 and the AI model 3200, and may classify A101, among shared resource metadata stored in the database 2000, as an optimal provided resource through the information classification module 3300.

In addition, the information processing module 3000 may refer to derived information including an optimal support destination and a provision method calculated by the AI model 3200, and may generate provision instruction information including, for example, “Optimal support destination: designated repository (not shown) or cooperating NGO in XX region,” and “Provision method: (i) transportation based on delivery truck (4020) and (ii) final section delivery by drone (4010),” or “Provision method: delivery truck (4020) only.”

In one embodiment, the resource providing module 4000 may perform provision of goods according to provision instruction information. For example, the resource providing module 4000 may determine a release point based on metadata stored in the database 2000, such as provider location, resource storage location, providable time window, and transportation availability, and may control bottled water to be released from the release point (e.g., a donation site near the provider location or a logistics hub). The resource providing module 4000 may assign a delivery truck (4020) to transport bottled water from the release point to a repository near the optimal support destination (not shown), and may assign a drone (4010) at the repository or final delivery point to perform final delivery to the requester or support organization.

In one embodiment, the resource providing module 4000 may manage provision status step by step during the provision process. For example, (a) release confirmation, (b) location tracking during transportation, (c) arrival confirmation, and (d) delivery confirmation may be performed, and events of each step (e.g., time, location, recipient confirmation information) may be stored in the database 2000. In addition, when provision failure or exceptional situations (e.g., road control, drone flight restriction, absence of recipient) occur, the resource providing module 4000 may request the information processing module 3000 to re-select provision routes or provision means by referring to alternative provision methods stored in the database (2000), such as a detour route of the truck 4020 or a route via an alternative repository.

In one embodiment, after completion of provision, the resource providing module 4000 may reflect provision results (e.g., actual provision time, loss rate, provision success) in the database 2000, and may deliver the provision results to the information processing module 3000 so that the provision results may be used as input data for calculating increments of social value and social contribution points.

The resource providing module 4000 may provide a registered medical service according to online 4030, which is a providing method among derived information registered in the Database by the AI model.

In one embodiment, assuming that Provider B registers a medical service as a service resource and a resource identifier is assigned, the information processing module 3000 may verify a requester's situation or demand (e.g., medical consultation required in a specific region) and may determine B201 as a provided resource by matching the request with metadata stored in the database 2000. In this case, the AI model 3200 may generate online 4030 as a provision method, and derived information may include, for example, “Provision method: creation of a video consultation session,” “Provision time: Jan. 31, 2025, 20:30,” “Language/interpretation requirement,” and “Provision method of access link.”

In one embodiment, the resource providing module 4000 may execute service provision in an online manner according to the derived information. For example, the resource providing module 4000 may transmit an access link or authentication token to a requester terminal 10 or a support organization terminal, and may interwork with Provider B's terminal or system to establish a video consultation session. In addition, the resource providing module 4000 may record whether service provision is completed (e.g., connection success, consultation time, consultation termination confirmation) and may store provision results in the database 2000. When service provision is delayed or fails, the resource providing module (4000) may request re-matching by retrieving an alternative provider or an alternative provision time window from the database 2000, or may request re-classification from the information processing module 3000.

In one embodiment, assuming that Provider C registers a resource of monetary value, virtual currency, or online points in the amount of 50 dollars and a second resource identifier is assigned, the information processing module 3000 may determine the second resource identifier as a provided resource according to verification results of the requester's necessity. Then, the AI model 3200 may generate online-based transmission (e.g., account transfer, point transfer, wallet address transfer) as a provision method. In this case, derived information may include recipient account or wallet information, transmission means, transmission time, and transaction verification method (e.g., receipt/hash value confirmation).

In one embodiment, the resource providing module 4000 may execute provision of money (points or virtual currency) according to the derived information. For example, the resource providing module 4000 may perform a transmission request to an authenticated recipient account and may store transmission results (success/failure, transaction time, transaction identifier) in the database 2000. In addition, when transmission fails, the resource providing module 4000 may apply an alternative payment method or retry policy, and if necessary, may request the information processing module 3000 to re-verify recipient information or designate an alternative recipient.

In one embodiment, the resource providing module 4000 may update metadata of the corresponding shared resource by reflecting provision results in the database 2000 after completion of provision. For example, result data such as actual provision time, provision cost, provision success rate, provision effect according to urgency, and recipient confirmation information may be accumulated. Such result data may be utilized as input data for training or inference of the AI model 3200, and consequently may be used to improve accuracy of determining optimal support destinations, evaluation values, provision methods, and calculation of social contribution points in the same or similar situations.

In this manner, the resource providing module 4000 may share resources using data stored in the database 2000 and the information processing module 3000.

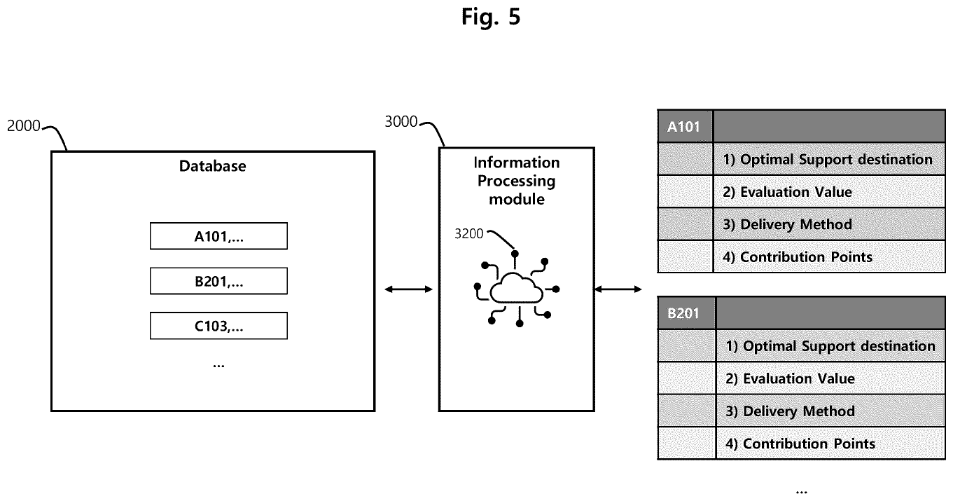

FIG. 5 discloses a method of obtaining derived information for each shared resource according to the above disclosure.

When a provider of a resource registers a resource to be shared in the database 2000, an identifier according to provided resources and providers may be generated.

Here, A101, B201, C103, . . . and the like are exemplified as identifiers of shared resources. According to such an identifier, information registered by a provider may be registered together in the database 2000.

Then, according to the identifier, the AI model 3200 of the information processing module 3000 may generate, for a resource corresponding to each identifier, 1) an optimal support region, 2) an evaluated value, 3) a providing method, and 4) (social) contribution points.

For example, for an optimal support region of a resource having an identifier, the AI model 3200 may classify a region in which providing time is minimized by calculating together a region physically closest to a providing region desired by the provider or a providing method.

As another example, the information processing module 3000 may generate a set of candidate support destinations from pre-registered support organizations, NGOs, and resource repositories (not shown) in the database 2000, by calculating distance to a desired provision region, accessibility, and types of resources that can be processed.

The information processing module 3000 may calculate a need score for each candidate support destination with respect to a resource type by using a demand prediction model.

The information processing module 3000 may calculate a match score between a resource corresponding to a resource identifier and a candidate support destination by using a matching score model.

The information processing module 3000 may select an optimal support destination based on an objective function combining the need score, the match score, and/or an expected provision time. For example, the objective function may be set to “increase the match score and the need score, and decrease the expected provision time”.

For the evaluated value of each resource, the AI model 3200 may set a general commercial value of a resource provided by a provider as an evaluated value, or may calculate, together with other factors such as an emergency situation or a providing method, add a weight to the evaluated value, and calculate a final evaluated value.

As another example, the information processing module 3000 may calculate an evaluation value of a registered resource by using a value evaluation model. The evaluation value may be calculated by reflecting weights such as urgency, impact, storage cost, and difficulty of provision on a basic value based on a market reference price, thereby deriving a final evaluation value.

For a providing method of each resource, the AI model 3200 may classify a providing method that secures minimum time or minimum efficiency by considering a transportation means of the resource between a location where the provider provided the resource and a location where the resource is actually to be provided.

As another example, the information processing module 3000 may determine a provision method to the optimal support destination by using a provision-method/route optimization module. The provision method may include at least one of a drone 4010, a delivery truck 4020, or online provision 4030, and may be a multimodal method combining multiple transportation means.

In the case of contribution points according to providing of each resource, the AI model 3200 may determine contribution points according to a ratio between a value of a resource provided by a provider and an actual social value.

$$Contribution points = ( 1 + increment in social value / evaulated value of the resource \qquad [ Equation 1 ]$$

Contribution points according to [Equation 1] may be referred to as social contribution points.

If a resource provided by a provider is delivered to a needed provider as the actual value, since there is no increment in social value, the contribution points may remain 1.

If necessary, the value of a resource provided by a provider may be adjusted in consideration of urgency, ripple effect, storage cost of the resource, and the like.

For a resource having high urgency of resource providing, since the possibility of being used urgently is high and storage cost decreases, the increment in social value increases.

For a resource having low urgency, since storage cost increases, the increment in social value decreases. In addition, provision of a needed resource by a provider at a time point having high urgency of resource providing may increase the increment in social value.

Resource providing at a time that is not a case of high urgency due to an issue such as a disaster may be calculated such that the increment in social value is not high.

And when a providing act of a provider of a resource having high urgency increases additional resource support by other providers, the increment in social value increases, but otherwise, there may be no increment.

A calculated value and an amount of the increment in social value may vary according to an embodiment, and thus are not specifically limited herein.

As another example, the information processing module 3000 may calculate social contribution points based on the evaluation value and increments of social value. The increments of social value may be calculated by reflecting factors such as urgency, provision time (whether SLA is satisfied), and impact (effect of inducing participation of other providers), and the calculation method may vary depending on embodiments.

The information processing module 3000 may store derived information including the optimal support destination, the evaluation value, the provision method, and the social contribution points in the database 2000. The derived information, together with registration information, may constitute metadata about shared resources.

In this manner, after a situation in which providing of resources is completed, the AI model 3200 may calculate a use value of each shared resource according to each resource identifier.

Then, when a resource provider continuously provides multiple resources, such contribution points may be obtained for the provided resources.

Contribution points for which a specific method of utilization and donation of such resources is calculated may be provided as social incentives for a resource provider.

Based on such incentives, a resource provider in society may have social incentives beyond simply supporting resources or helping preserve the environment through surplus resources.

In one embodiment, the AI model 3200 may be implemented as a single model but may also be implemented in the form of a pipeline or an ensemble including a plurality of sub-models and/or optimization modules. For example, the AI model 3200 may include at least one of the following components.

To classify demand destinations of provided resources, the AI model 3200 may include a demand prediction model. The AI model 3200 may be a model for predicting demand for a specific resource type (e.g., bottled water, medicines, medical services, etc.) in a specific region, and may use as input disaster, climate, economic, health indicators, population or seasonality information, and past support history. For example, the demand prediction model may apply to a model that predicts demand within a predetermined future period by using a region and a shared resource as independent variables. Such a demand prediction model may include one or more of a time-series prediction model, a regression model, a tree-based model, or a deep learning model.

To classify candidate destinations of resources, the AI model 3200 may further include a matching score model. The AI model 3200 may be a model for scoring suitability between registered resources and candidate support destinations (or demanders, organizations, regions) and may be implemented as a classification model or a ranking model. The matching score model may perform matching of candidate support destinations by using provider registration information and regional identifiers as independent variables. For example, by applying a gradient boosting-based model, logistic regression, or a neural network-based model, the suitability of candidate support destinations may be calculated in the form of a score.

To evaluate the value of provided resources, the AI model 3200 may include a value evaluation model. The AI model 3200 may be a model for calculating an evaluation value of registered resources, and may calculate a reference value close to a market price, and adjust the final evaluation value by reflecting factors such as urgency, impact, storage cost, and difficulty of provision. The value evaluation model may calculate such a final value by using a regression model and/or a rule-based weighting model.

For optimization of provision methods and routes of registered resources, the AI model 3200 may select and apply algorithms for determining transportation means and routes required for resource provision. For example, the AI model 3200 may calculate an optimal provision method by setting at least one of minimization of provision time, minimization of provision cost, and/or minimization of carbon emissions as an objective function. To select the optimal provision method, the AI model 3200 may apply linear programming, mixed integer programming, or heuristic-based optimization.

In addition, the AI model 3200 may include a module for calculating (social) contribution points based on evaluation values and increments of social value, and may use a point calculation formula such as Mathematical Formula 1 described above.

In another embodiment, the AI model 3200 may convert registration information into feature values and obtain derived information based thereon. The AI model 3200 may calculate provider-related feature values based on a provider trust score, past provision frequency, provision success rate, and continuity of provision history.

The AI model 3200 may generate resource-related feature values based on registered information such as resource type, kind of resource, quantity, expiration duration, storage conditions, and risk of damage. The AI model 3200 may generate time-or region-related feature values of resources based on registration information such as distance between a provider location and candidate support destinations, providable time windows, and seasonal indices.

The AI model 3200 may generate demand feature values of regions requiring resources based on demand scores, occurrence of disasters, water stress indices, and poverty indices. The AI model 3200 may generate provision-method-related feature values based on transportation availability (e.g., whether drones are available, accessibility of roads or airports), and processing capacity of intermediate hub repositories.

As such, by calculating necessary feature values from registered information and utilizing relationships among the calculated feature values, the AI model 3200 may provide decision values required for provision and support of resources.

Accordingly, the embodiment may provide a system having an effect of increasing and sharing surplus or donation resources in society.

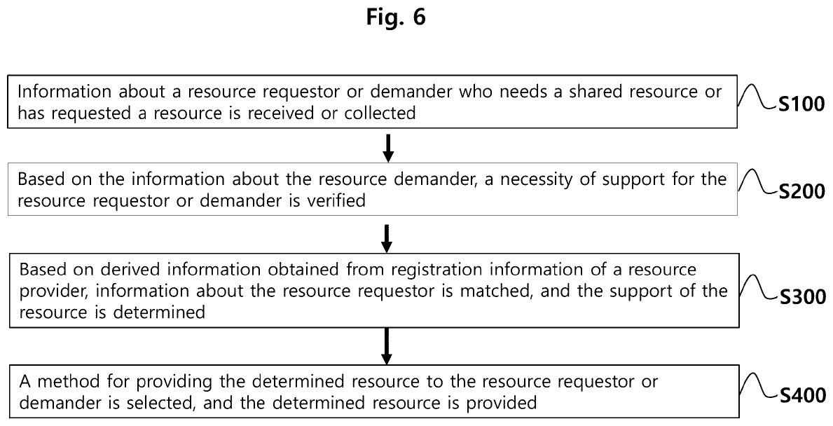

FIG. 6 discloses an embodiment of a method for sharing resources according to the above disclosure.

Information about a resource requestor or demander who needs a shared resource or has requested a resource is received or collected (S100). A detailed examples thereof are illustrated in FIGS. 1 and 3 and the corresponding descriptions of the figures.

Based on the information about the resource requestor or demander, a necessity of support for the resource requestor or demander is verified (S200). A detailed example thereof is illustrated in FIGS. 1 and 3.

A resource provider registers information on a resource to be shared in a database. Then information is derived from the registration information of the resource provider based on an artificial intelligence model. Based on the derived information obtained from the registration information of a resource provider, information about the resource requestor whose need has been verified is matched, and support of the resource is determined (S300). A detailed example thereof is illustrated in FIGS. 1, 2, and 5.

A received or collected resource may be registered in the database, and, for the registered resource, derived information for effective providing of the registered resource may be generated or classified and then registered again in the database. This is disclosed in FIGS. 2 and 5.

A method for providing the determined resource to the resource demander is selected, and the determined resource is provided (S400). A detailed example thereof is disclosed in FIG. 4.

According to the disclosed embodiment, when a shared resource is needed or information about a resource requestor is received or collected, it is possible to verify a request of the resource requestor based on the information about the resource requestor.

When information about a resource requestor whose request has been verified is matched with metadata of a previously provided resource and a resource to be supported is determined, it is possible to provide the determined resource to the resource requestor.

According to the above disclosures, multiple countries, or societies or companies of those countries, can share resources without being limited to a region, and this can help solve the problem of resource imbalance.

According to the above disclosures, resources can be shared beyond such regional scopes or social categories, rather than resource sharing according to regional, social, or governmental efforts, and this can help solve an imbalance problem.

According to the above disclosures, beyond merely sharing resources in society, the resources may be managed and provided as social incentives as an advantage for a provider.

What is claimed is:

1. A method of sharing a resource, the method comprising:
receiving or collecting information on a resource requestor;
verifying a request of the resource requestor based on the information;
deriving information from registration information of a resource provider based on an artificial intelligence model;
matching the derived information with the information on the resource requestor to determine, based on the matched information, a resource to be shared; and
requesting a delivery system to deliver the determined resource to the resource requestor based on the derived information,
wherein the derived information includes contribution points according to a ratio of a value of a resource provided by the resource provider to a social value calculated from the determined shared resource.

2. The method of claim 1, wherein the deriving information further includes an optimal support destination of the determined resource.

3. The method of claim 1, wherein the deriving information further includes an evaluation value of the determined resource.

4. The method of claim 1, wherein the information on a resource requestor is crawled by an automated crawling operation through a public API (application programming interface).

5. The method of claim 1, wherein the delivery of the determined resource is delayed or fails, the matched information is retrieved, and an alternative provider or an alternative provision time window is generated from the artificial intelligence model.

6. An apparatus for sharing a resource, the method comprising:
a database storing data; and
a processor processing the data;
wherein the processor is configured to:
receive or collect information on a resource requestor;
verify a request of the resource requestor based on the information;
derive information from registration information of a resource provider based on an artificial intelligence model;
match the derived information with the information on the resource requestor to determine, based on the matched information, a resource to be shared; and
request a delivery system to deliver the determined resource to the resource requestor based on the derived information,
wherein the derived information includes contribution points according to a ratio of a value of a resource provided by the resource provider to a social value calculated from the determined shared resource.

7. The apparatus of claim 6, wherein the deriving information further includes an optimal support destination of the determined resource.

8. The apparatus of claim 6, wherein the deriving information further includes an evaluation value of the determined resource.

9. The apparatus of claim 6, wherein the information on a resource requestor is crawled by an automated crawling operation through a public API (application programming interface).

10. The apparatus of claim 6, wherein the delivery of the determined resource is delayed or fails, the matched information is retrieved, and an alternative provider or an alternative provision time window is generated from the artificial intelligence model.

11. A non-transitory storage medium for storing a computer-readable program for sharing a resource, the program performing instructions comprising:
receiving or collecting information on a resource requestor;
verifying a request of the resource requestor based on the information;
deriving information from registration information of a resource provider based on an artificial intelligence model;
matching the derived information with the information on the resource requestor to determine, based on the matched information, a resource to be shared; and
requesting a delivery system to deliver the determined resource to the resource requestor based on the derived information,
wherein the derived information includes contribution points according to a ratio of a value of a resource provided by the resource provider to a social value calculated from the determined shared resource.

12. The non-transitory storage medium of claim 11, wherein the deriving information further includes an optimal support destination of the determined resource.

13. The non-transitory storage medium of claim 11, wherein the deriving information further includes an evaluation value of the determined resource.

14. The non-transitory storage medium of claim 11, wherein the information on a resource requestor is crawled by an automated crawling operation through a public API (application programming interface).

15. The anon-transitory storage medium of claim 11, wherein the delivery of the determined resource is delayed or fails, the matched information is retrieved, and an alternative provider or an alternative provision time window is generated from the artificial intelligence model.
